(19) United States
(12) Patent Application Publication
(10) Pub. No.: US 2005/0279602 A1
(43) Pub. Date: Dec. 22, 2005

(54) Planar coupling assembly for an automatic transmission

(75) Inventor: Stephen M. Ruth, Holly, MI (US)

Correspondence Address: BROOKS KUSHMAN P.C., 1000 TOWN CENTER, TWENTY-SECOND FLOOR, SOUTHFIELD, MI, 48075, US

(73) Assignee: Means Industries, Inc., Saginaw, MI (US)

(21) Appl. No.: 10/869,583

(22) Filed: Jun. 16, 2004

(51) Int. Cl. F16D 47/04

(52) U.S. Cl. 192/48.3; 192/46; 192/48.92

(57) ABSTRACT

A planar overrunning coupling assembly for a geared transmission. The coupling assembly has a circular pocket plate, a notch plate, and torque transmitting struts in pockets formed in the pocket plate. The geometry of the pockets prevents displacement of the struts toward the notch plate under the influence of centrifugal force when the pocket plate overruns the notch plate. The pocket plate and the notch plate define in part friction disc coupling assemblies.

### BACKGROUND OF THE INVENTION

1. Field of the Invention

The invention relates to a planar coupling assembly for establishing and disestablishing a torque flow path in a geared multiple-ratio transmission for an automotive vehicle powertrain.

2. Background Art

Prior art U.S. Pat. No. 5,964,331 discloses a one-way clutch comprising a pocket plate and a notch plate situated in a juxtaposed adjacent relationship. One-way clutches of this kind are sometimes referred to as planar clutches because the adjacent juxtaposed surfaces are situated in radial planes with respect to the axis of the clutch.

For purposes of this disclosure, the term coupling should be interpreted to include clutches or brakes wherein one of the plates is drivably connected to a torque delivery element of a transmission and the other plate is drivably connected to another torque delivery element or is anchored and held stationary with respect to a transmission housing. The terms coupling, clutch and brake may be used interchangeably.

The pocket plate is provided with angularly disposed recesses or pockets about the axis of a one-way clutch. The pockets are formed in the planar surface of the pocket plate. Each pocket receives a torque transmitting strut, one end of which engages an anchor point in a pocket of the pocket plate. An opposite edge of the strut, which may hereafter be referred to as an active edge, is movable from a position within the pocket to a position in which the active edge extends outwardly from the planar surface of the pocket plate. The struts may be biased away from the pocket plate by individual springs.

The notch plate is formed with a plurality of recesses or notches located approximately on the radius of the pockets of the pocket plate. The notches are formed in the planar surface of the notch plate.

Another example of an overrunning planar clutch is disclosed in U.S. Pat. No. 5,597,057. Both the '331 and '057 patent are assigned to the assignee of the present invention.

In a transmission gearing installation that includes a planar clutch of know design, such as the clutch disclosed in the '331 patent and in the '057 patent, the pocket plate will rotate relative to the notch plate as the notch plate is held stationary by a spline connection between the periphery of the notch plate and a transmission housing. A friction disc assembly selectively anchors the pocket plate when a torque reaction point for the transmission gearing is desired.

During operation of a planar clutch of known design in selected transmission gear ratios, it is necessary to anchor the pocket plate to provide a torque reaction for an associated torque transmitting gear element of the transmission. The springs that act on the individual torque transmitting struts then urge the struts toward the notch plate to effect engagement of the active edge of the struts with the notches of the notch plate, thus establishing a torque reaction point for the torque transmitting gear element. If the pocket plate rotates at the initiation of a ratio shift that requires a torque reaction on the one-way clutch assembly, a centrifugal force is developed on each torque transmitting strut, causing it to engage at its radially outward active edge with an edge of its pocket. When the overrunning clutch is in its overrunning mode and is operated at high speeds, centrifugal force developed due to the mass of the rotating strut tends to cause unwanted movement of the strut.

Typically, the pocket has a radially outward edge that is formed with a positive angularity or draft angle with respect to the axis of rotation. The centrifugal force acting on the strut then will have an axial component that may cause the strut to shift into engagement with the notch plate. This interferes with the effective overrunning action of the one-way clutch and causes wear and undesirable noise. This disadvantage is of significance since continuous overrunning of the one-way clutch occurs during a high percentage of the overall operating time of the transmission.

A one-way planar clutch assembly of the kind disclosed in the '331 patent and in the '057 patent typically is used in combination with at least one friction disc assemblies, the friction disc assembly defining a brake or a clutch that establishes a torque flow path that is parallel to the torque flow path established by the one-way planar clutch assembly. Thus, multiple clutch assemblies are required, which complicates the overall transmission design and increases cost and transmission assembly time.

### SUMMARY OF THE INVENTION

According to one feature of the one-way clutch assembly of the present invention, provision is made for eliminating the adverse effects of centrifugal force acting on the one-way clutch torque transmitting struts, thereby improving the freewheeling performance of the clutch assembly, especially at high overrunning clutch speeds. This is done by providing a 0° draft angle on the radially outward edge of the pockets in which the struts are situated. The pockets may be designed also with a negative draft angle to further enhance the beneficial holding effect that overcomes the adverse effect of centrifugal force acting on the struts.

According to another feature of the invention, the pocket plate is provided with an externally-splined extension formed integrally with the pocket plate itself. The extension is adapted to carry clutch plates or discs that form a part of a friction clutch assembly in a gearing system for an automatic transmission. In a transmission environment that requires the use of a friction clutch assembly in combination with an overrunning clutch or brake, the one-way planar clutch assembly of the invention makes it possible to integrate the torque transmitting elements of the friction clutch assembly with the overrunning coupling elements of the planar one-way clutch assembly. This simplifies the design and provides an economy of space in an automatic transmission gear system.

Another feature of the invention includes a planar friction surface on the notch plate, which may form a friction disc clutch or brake reaction surface for a secondary friction clutch assembly. Thus, the planar overrunning clutch assembly of the invention can be integrated with two friction clutch assemblies in an automatic transmission system thereby further simplifying the overall design and effecting a further reduction in the space required for the transmission friction elements. An additional benefit of the integration of the friction clutch assemblies and the overrunning clutch assembly is a further reduction in the number of elements and a further reduction in manufacturing costs including reduced assembly time and cost.

It is possible to provide multiple engagements of the torque transmitting struts for each relative angular position of the pocket plate with respect to the notch plate. The backlash inherent in the planar one-way clutch assembly thus can be reduced and the torque capacity of the one-way clutch assembly can be increased by the multiple engagements.

### BRIEF DESCRIPTION OF THE DRAWINGS

FIG. 1 is a partial cross-sectional view of a gearing system that includes the planar one-way clutch assembly of the invention in combination with two friction clutch assemblies;

FIG. 2 is an enlarged detail view of a portion of the cross-sectional view of FIG. 1 wherein the elements of the planar one-way clutch assembly of the invention are emphasized;

FIG. 3a is an isometric view of a pocket plate, which forms an element of the planar one-way clutch assembly of the invention;

FIG. 3b is an isometric view of a notch plate for use with the pocket plate of FIG. 3a in the assembly of FIG. 2;

FIG. 3c is an isometric view of a torque transmitting strut located in a pocket of the pocket plate of FIG. 3a;

FIG. 3d is a cross-sectional view of one of the pockets of the pocket plate of FIG. 3a as seen from the plane of section line 3d-3d of FIG. 3a;

FIG. 4 is a plan view of the planar surface of the pocket plate of FIGS. 1, 2 and 3a;

FIG. 5 is a plan view of the planar surface of the notch plate of FIGS. 1, 2 and 3b;

FIG. 6 is a cross-sectional view of the pocket plate of FIG. 4 as seen from the plane of section line 6-6 of FIG. 4; and

FIG. 7 is a cross-sectional view of a pocket plate similar to the pocket plate disclosed in prior art U.S. Pat. No. 5,964,331, wherein a positive draft angle is present at a radially outward wall of the pocket.

### DETAILED DESCRIPTION OF THE PREFERRED EMBODIMENTS

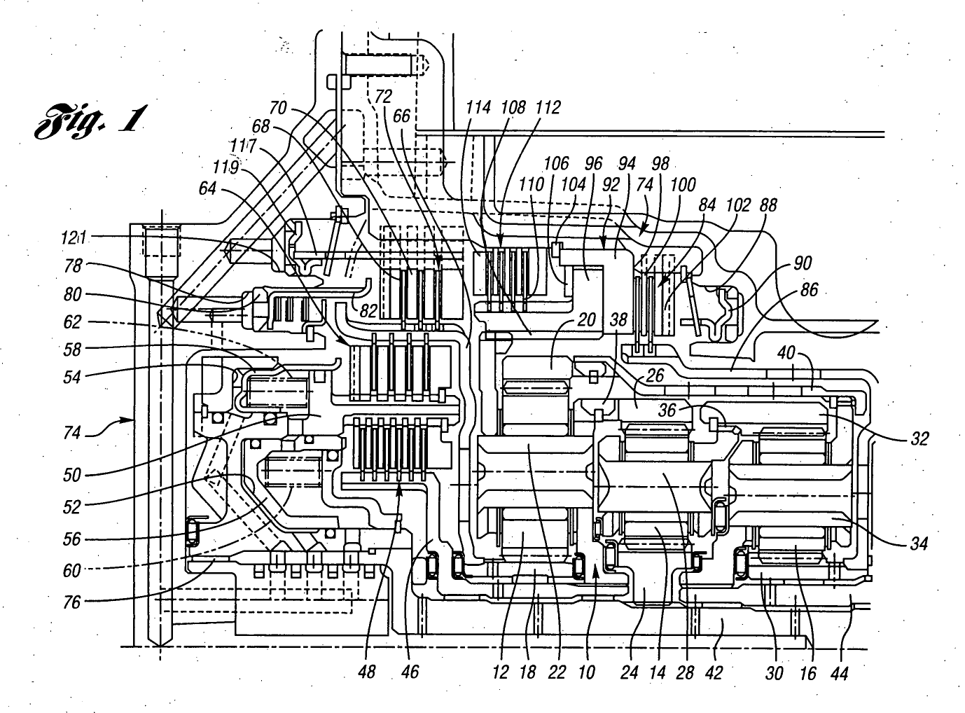

An automatic transmission gear system incorporating the invention is shown in the partial cross-sectional view of FIG. 1. It includes a planetary gearing arrangement 10, which comprises three simple planetary gear units 12, 14, and 16. Gear unit 12 includes a sun gear 18, a ring gear 20, and a planetary carrier 22. Gear unit 14 comprises a sun gear 24, a ring gear 26, and a planetary carrier 28. Gear unit 16 comprises a sun gear 30, a ring gear 32, and a planetary carrier 34.

Carrier 28 is drivably connected to sun gear 32, as shown at 36. Carrier 22 is drivably connected to ring gear 26, as shown at 38. Ring gear 20 is drivably connected to planetary carrier 34 by a torque transfer member 40.

A torque input shaft, which corresponds to the turbine shaft of a hydrokinetic torque converter (not shown), is designated by reference numeral 42. It is splined to sun gear 24. Torque output sleeve shaft 44 is splined to carrier 34, and carrier 22 is splined to friction clutch element 46 of a multiple disc clutch assembly 48, which is engaged during operation of the transmission in the fourth, fifth and sixth speed ratio.

Clutch plates register with clutch discs of the clutch assembly 48. Clutch plates are connected to clutch member 50, which defines in part spaced annular clutch cylinders, as shown at 52 and 54. An annular piston 56 is disposed in clutch cylinder 52 and an annular piston 58 is disposed in annular cylinder 54. The pistons 56 and 58 are biased to a clutch release position by clutch return springs 60 and 62, respectively. The cylinder 52 and the piston 56 define a pressure chamber, which, when pressurized causes piston 56 to frictionally engage the clutch plates and clutch discs of the multiple disc clutch assembly 48 to establish a driving connection between carrier 22 and clutch element 50.

Internally splined clutch plates of a multiple disc clutch assembly 64 are splined to the clutch element 50. Externally splined clutch plates of multiple disc clutch assembly 64 are drivably connected to sun gear 18 by clutch element 66.

Clutch element 66 is connected drivably to friction brake discs 68, which register with friction plates 70 of a multiple disc brake assembly 72.

Clutch disc assembly 64 is engaged during operation in the third and fifth speed ratio, as well as in reverse drive. Brake disc assembly 72 is engaged during operation in second ratio and sixth ratio.

The stationary transmission housing 74 rotatably supports turbine shaft 42, as shown at 76. Housing 74 defines an annular brake pressure chamber 78 in which is situated annular piston 80. A brake actuator element 82 carried by the piston 80 is engageable with the brake disc assembly 72 to establish a torque reaction point for sun gear 18.

Sun gear 16 is drivably connected to brake disc assembly 84 by means of torque transfer element 86. Housing 74 defines an annular cylinder 88, which receives annular piston 90.

The planar clutch assembly of the invention is illustrated in FIG. 1 at 92. It comprises a notch plate 94, which envelopes pocket plate 96. The planar annular surface 98 provides a brake disc reaction surface, which is engaged by an adjacent brake disc of the brake disc assembly 84. Clutch plates of the brake disc assembly 84 are externally splined to the transmission housing 74, as shown at 100.

The brake disc assembly 84 is frictionally engaged when pressure is applied the piston 90, which actuates pressure plate 102 of the brake disc assembly 84.

The notch plate 94 acts as the reaction element for the brake disc assembly 84. It is splined to the transmission housing 74 and is secured within the transmission housing against axial displacement by snap ring 104 located in a snap ring groove in the transmission housing 74.

The pocket plate 96 is held fast within the notch plate 94 by a snap ring 106 situated in a snap ring groove formed in the pocket plate 94.

Pocket plate 96 has an axial extension 116, best seen in FIG. 2, which is externally splined to internally splined friction brake discs 110 of a multiple disc brake assembly 112. Splined clutch plates are connected to transmission housing 74. Brake pressure plate 114 is engaged by an actuator element 117, which in turn is carried by brake actuator piston 118. The pocket plate extension 116 has internal splines 108 to establish a splined driving connection to carrier 22, as best seen in FIG. 1.

An annular cylinder 121 formed in the transmission housing 74 receives a piston 119. Internal fluid pressure passages provide actuating pressure to the cylinder 121 to create a brake actuating force on the piston 119. That force is transmitted through the actuator element 117, which engages pressure plate 114 to apply the brake disc assembly 112. This anchors the carrier 22 of the planetary gear unit 12.

FIG. 2 is an enlarged detail view of the planar clutch assembly 92 and the friction brake assembly 84. The piston 90′ of FIG. 2 corresponds to the piston 90 of FIG. 1, the later being formed as a steel stamping whereas the piston 90′ is a machined part. In each instance, when the piston or the multiple disc brake assembly 84 is subjected to brake actuating pressure, a force is applied to the pressure plate 102. The reaction for that actuating force on the pressure plate is accommodated by the notch plate 94. The reaction force is transmitted to the transmission housing through snap ring 104.

The surface 98 on the notch plate is fully precision ground prior to assembly so that it can act as a backing plate for the friction disc pack. It thus is not necessary with the design illustrated in FIGS. 1 and 2 to provide a separate backup plate for the friction brake assembly. The integrated design illustrated in FIGS. 1 and 2 incorporates common features for the planar clutch assembly 92 and the friction brake assembly 84, thereby eliminating components and reducing the packaging space for the torque transmitting elements of the transmission.

As previously mentioned, the brake disc assembly 84 is applied during operation in the first, second, third and fourth speed ratios for the transmission. This provides a coast braking torque for the transmission during forward drive. Reaction torque is transmitted from the sun gear 30 and from the torque transfer element 86 through the engaged brake disc assembly 84. During forward drive, reaction torque on the sun gear 30 is accommodated by the planar one-way clutch assembly 92.

When the planar one-way clutch assembly is active, forward driving torque is transmitted from the carrier 22 to the transmission housing through the pocket plate during first, second, third and fourth gear ratio operation. When the transmission is operating in the fifth and sixth speed ratio, pocket plate 96 will assume a freewheeling condition whereby the pocket plate will overrun the stationary notch plate. Coast braking during low speed ratio operation and reverse drive operation can be achieved by engaging multiple disc brake assembly 112, which includes friction brake discs 110 that are splined to extension 116 on the pocket plate 96.

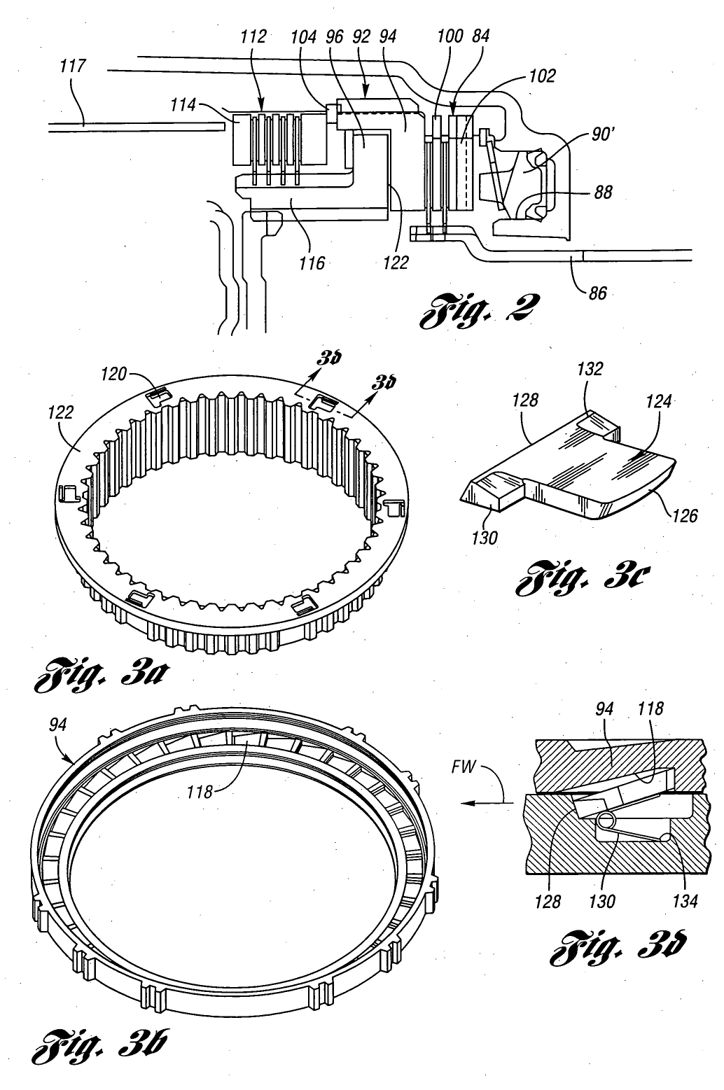

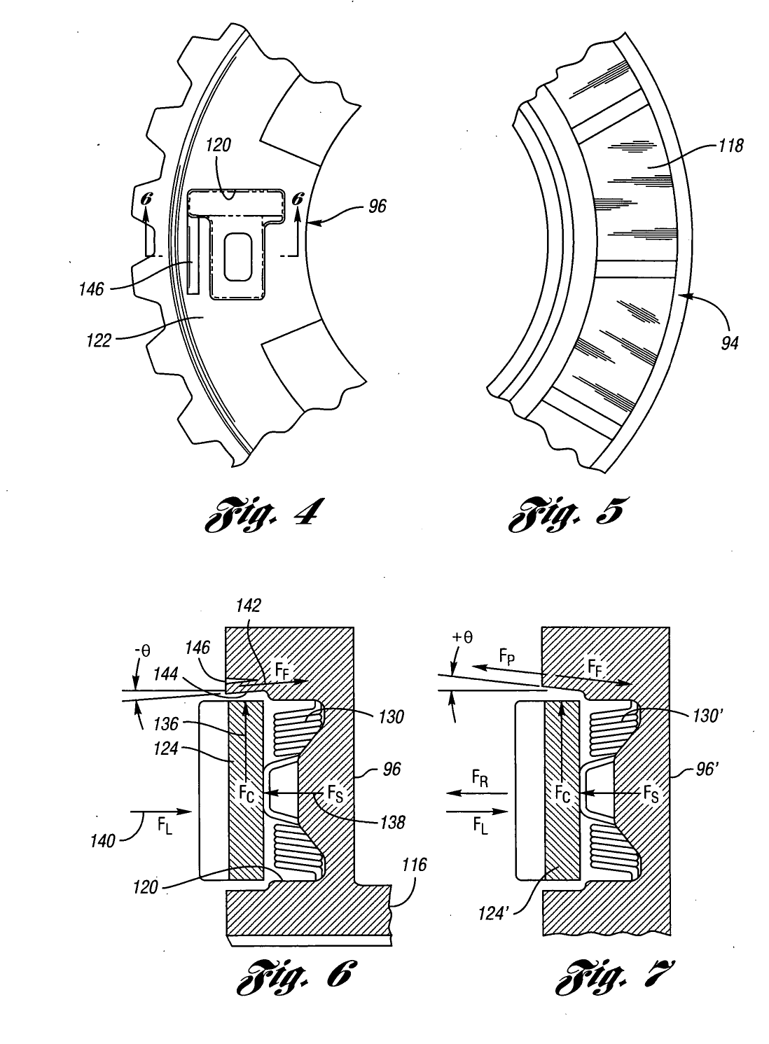

The stationary externally splined notch plate, as best seen in FIG. 3b and in FIG. 5, includes a plurality of ramped recesses or notches 118 throughout the entire periphery of the notch plate. These notches are situated in juxtaposed adjacent relationship with respect to pockets 120 formed in the planar annular surface 122 of the pocket plate. The pockets 120 are disposed about the periphery of the pocket plate, as seen in FIG. 3a.

A torque transmitting strut 124 is situated in each pocket. The struts are best seen in FIG. 3c. They include a notch engaging active edge 126 and an anchor edge 128. The edge 128 is elongated in a tangential direction to provide anchor shoulders 132 and 132′, which are received in a radially enlarged portion of the pockets 120.

FIG. 3d shows the anchor edge 128 engaged with one edge of the pocket 120. A spring, preferably a leaf-type or hairpin-type spring, as shown in FIG. 3d at 130, is supported by a base surface 134 of the pocket 120. The spring engages the underside of the torque transmitting strut 124, as best seen in FIG. 3d, and urges the strut 124 in a radially outward direction. This causes the strut to pivot about anchor edge 128. The active notch plate engaging edge 126 is moved outwardly so that it is engageable with the notches 118 as the pocket plate moves rotatably relative to the notch plate.

The number of pockets may be different than the number of pockets to reduce backlash. They may be arranged relative to the pockets to effect multiple strut engagements, thereby increasing coupling torque capacity.

When the pocket plate moves rotatably in the direction of the directional vector FW in FIG. 3d, the torque transmitting strut 126 will ratchet across the notches 118. If the relative motion of the pocket plate is zero, the notch plate engaging active edge 126 of the struts 124 will engage an edge of the notches 118 thereby preventing reverse motion of the pocket plate relative to the notch plate.

When the planar one-way clutch assembly is freewheeling, a centrifugal force is developed on the torque transmitting struts 124, as indicated in FIG. 6 by the force vector 136.

In FIG. 6, the spring force acting on the torque transmitting strut 124 is represented by the force vector 138. The fluid pressure force created by the effect of the strut displacing transmission fluid when moving into the notch plate is represented by the vector 140. Based upon empirical data, this force 140 has been shown to have a minimal effect, and for all practical purposes it can be ignored.

The centrifugal force shown by force vector 136 acting on the strut creates a centrifugal force component vector 142 that tends to resist displacement of the strut out of the pocket 120 when the planar one-way clutch assembly is freewheeling. Force vector 142 is created by reason of a negative draft angle 144 formed at the radially outward edge of the pocket 120. The negative draft angle is created during manufacture of the pocket plate. A negative draft angle can be achieved by upsetting the metal at the radially outward wall of a pocket 120, as shown at 146. A punching tool may be used during the manufacture of the pocket plate to upset the metal at the radially outward edge of the pocket 120.

Preferably, the pocket plate and the notch plate can be formed using powder metal technology. During the sintering operation in the powder metal casting technique, the notches 146 can be formed readily when the pocket plate still is in its heated state while it is most malleable. It has been demonstrated that the negative draft angle on the pockets 120 will resist displacement of the struts 124 even when the pocket plate rotates at high speeds; for example, speeds greater than 2500 rpm. This greatly improves the overrunning clutch performance, reduces wear on the struts, and avoids any tendency of the struts to create noise due to ratcheting of the struts across the pockets of the pocket plate when the planar overrunning clutch assembly is freewheeling.

In contrast to the design of FIG. 6, FIG. 7 illustrates a planar overrunning clutch design of the kind shown in U.S. Pat. No. 5,918,715. When the planar overrunning clutch assembly is in a freewheeling state, the centrifugal force vector F_{C} will create a “push-out” force component F_{P}. When combined with fluid pressure force F_{L} and spring force F_{S}, the resultant force F_{R} is developed, which tends to move the torque transmitting strut 124′ outwardly where it can interfere with the freewheeling action of the strut plate relative to the pocket plate. The draft angle θ is a positive value in the case of the design of FIG. 7, whereas the draft angled for the design of FIG. 6 is negative. In some instances, the angle θ shown in FIG. 6 can be near or at a zero value. The actual negative draft that can be used depends upon design characteristics of the gearing with which the planar overrunning clutch is used.

Although an embodiment of the invention has been disclosed, it will be apparent to persons skilled in the art that modifications may be made without departing from the scope of the invention. All such modifications and equivalents thereof are intended to be covered by the following claims.

1. A planar one-way coupling for use in a geared power transmission having a transmission housing and multiple torque transmitting elements, the coupling comprising:
a circular notch plate anchored to the transmission housing;
a circular pocket plate connected to a torque transmitting element of the transmission;
the notch plate and the pocket plate having a common axis, each plate having a planar, radially-disposed annular surface, the annular surfaces being disposed in adjacent, juxtaposed relationship;
a plurality of notches in the annular surface of the notch plate, the notches being spaced about the common axis, each notch having an abutment shoulder;
a plurality of pockets in the annular surface of the pocket plate, the pockets being disposed about the common axis, each pocket having a torque reaction edge disposed in a generally radial direction and a radially outward edge;
a torque transmitting strut in each pocket, each strut having a pivotal active edge engageable with the torque reaction edge of a pocket in the pocket plate and an active edge movable about the reaction edge of a pocket outwardly toward the annular surface of the notch plate; and
a strut spring in each pocket of the pocket plate engageable with a strut, each spring urging a strut into engagement with a notch of the notch plate when relative rotary motion of the pocket plate with respect to the notch plate approaches zero, whereby the active edge of the strut engages an abutment shoulder in a notch of the notch plate;
the radially outward edge of the pockets of the pocket plate being displaced radially inward at the annular surface of the pocket plate thereby establishing a force component of a centrifugal force on a torque transmitting strut in each pocket that opposes a force of a spring in each pocket, thereby improving freewheeling performance of the planar one-way coupling.

2. The planar one-way coupling set forth in claim 1 wherein the radially outward edge of the pockets is characterized by a negative draft that defines a negative angle with respect to the common axis.

3. A planar one-way coupling for use in a geared power transmission having a transmission housing and multiple torque transmitting elements, the coupling comprising:
a circular notch plate anchored to the transmission housing;
a circular pocket plate connected to a torque transmitting element of the transmission;
the notch plate and the pocket plate having a common axis, each plate having a planar, radially-disposed annular surface, the annular surfaces being disposed in adjacent, juxtaposed relationship;
a plurality of notches in the annular surface of the notch plate, the notches being spaced about the common axis, each notch having an abutment shoulder;
a plurality of pockets in the annular surface of the pocket plate, the pockets being disposed about the common axis, each pocket having a torque reaction edge disposed in a generally radial direction and a radially outward edge;
a torque transmitting strut in each pocket, each strut having a pivotal active edge engageable with the torque reaction edge of a pocket in the pocket plate and an active edge movable about the reaction edge of a pocket outwardly toward the annular surface of the notch plate; and
a strut spring in each pocket of the pocket plate engageable with a strut, each spring urging a strut into engagement with a notch of the notch plate when relative rotary motion of the pocket plate with respect to the notch plate approaches zero, whereby the active edge of the strut engages an abutment shoulder in a notch of the notch plate;
the radially outward edge of the pockets of the pocket plate being characterized by a zero draft angle relative to the common axis whereby a force component of centrifugal force on each strut in the direction of the common axis is avoided during relative rotary motion of the pocket plate and the notch plate.

4. A planar one-way coupling for use in a geared power transmission having a transmission housing and multiple torque transmitting elements, the coupling comprising:
a circular notch plate anchored to the transmission housing;
a circular pocket plate connected to a torque transmitting element of the transmission;
the notch plate and the pocket plate having a common axis, each plate having a planar, radially-disposed annular surface, the annular surfaces being disposed in adjacent, juxtaposed relationship;
a plurality of notches in the annular surface of the notch plate, the notches being spaced about the common axis, each notch having an abutment shoulder;
a plurality of pockets in the annular surface of the pocket plate, the pockets being disposed about the common axis, each pocket having a torque reaction edge disposed in a generally radial direction and a radially outward edge;
a torque transmitting strut in each pocket, each strut having a pivotal active edge engageable with the torque reaction edge of a pocket in the pocket plate and an active edge movable about the reaction edge of a pocket outwardly toward the annular surface of the notch plate; and
a strut spring in each pocket of the pocket plate engageable with a strut, each spring urging a strut into engagement with a notch of the notch plate when relative rotary motion of the pocket plate with respect to the notch plate approaches zero whereby the active edge of the strut engages an abutment shoulder in a notch of the notch plate;
the radially outward edge of the pockets being displaced at the annular surface of the pocket plate thereby limiting outward movement of the active edge of each torque transmitting strut toward the notch plate when the pocket plate freewheels relative to the notch plate.

5. A planar one-way coupling for use in a geared power transmission having a transmission housing, multiple torque transmitting elements, and at least one friction disc coupling assembly, the coupling comprising:
a circular notch plate and a circular pocket plate with a common axis, each plate having a planar, radially disposed, annular surface, the annular surfaces being disposed in adjacent, juxtaposed relationship;
a plurality of notches in the annular surface of the notch plate, the notches being spaced about the common axis, each notch having an abutment shoulder;
a plurality of pockets in the annular surface of the pocket plate, the pockets being disposed about the common axis;
each pocket having a torque reaction edge disposed in a generally radial direction and a radially outward edge; and
a torque transmitting strut in each pocket, each strut having a pivotal active edge engageable with the torque reaction edge of a pocket in the pocket plate and an active edge movable about the reaction edge of a pocket outwardly toward the annular surface of the notch plate;
the friction disc coupling assembly having a splined member formed on the pocket plate, first friction elements carried by the splined member, second friction elements disposed adjacent the first friction elements; and
a pressure actuator means for applying a frictional engaging force to the friction elements.

6. The planar one-way coupling set forth in claim 5 wherein the friction discs are located on one axial side of the pocket plate and the notch plate is located on the opposite axial side of the pocket plate.

7. A planar one-way coupling for use in a geared power transmission having a transmission housing, multiple torque transmitting elements, and at least one friction disc coupling assembly, the coupling comprising:
a circular notch plate and a circular pocket plate with a common axis, each plate having a planar, radially disposed, annular surface, the annular surfaces being disposed in adjacent, juxtaposed relationship;
a plurality of notches in the annular surface of the notch plate, the notches being spaced about the common axis, each notch having an abutment shoulder;
a plurality of pockets in the annular surface of the pocket plate, the pockets being disposed about the common axis;
each pocket having a torque reaction edge disposed in a generally radial direction and a radially outward edge;
a torque transmitting strut in each pocket, each strut having a pivotal active edge engageable with the torque reaction edge of a pocket in the pocket plate and an active edge movable about the reaction edge of a pocket outwardly toward the annular surface of the notch plate;
the friction disc coupling assembly having a splined member connected to a torque transmitting element of the transmission, first friction discs carried by the splined member, second friction discs disposed adjacent the first friction discs and a pressure actuator means for applying a frictional engaging force to the friction discs;
the notch plate having a circular planar surface adjacent the friction disc coupling assembly; and
a coupling actuator means for applying a friction disc engaging force to said friction discs, the notch plate providing a reaction force for the frictional engaging force applied to the friction discs as the planar surface on the notch plate is engaged by an adjacent friction disc.

8. A planar one-way coupling for use in a geared power transmission having a transmission housing, multiple torque transmitting elements, and at least one friction disc coupling assembly, the coupling comprising:
a circular notch plate and a circular pocket plate with a common axis, each plate having a planar, radially disposed, annular surface, the annular surfaces being disposed in adjacent, juxtaposed relationship;
a plurality of notches in the annular surface of the notch plate, the notches being spaced about the common axis, each notch having an abutment shoulder;
a plurality of pockets in the annular surface of the pocket plate, the pockets being disposed about the common axis;
each pocket having a torque reaction edge disposed in a generally radial direction and a radially outward edge;
a torque transmitting strut in each pocket, each strut having a pivotal active edge engageable with the torque reaction edge of a pocket in the pocket plate and an active edge movable about the reaction edge of a pocket outwardly toward the annular surface of the notch plate;
a first friction disc coupling assembly having a first splined member formed on the pocket plate, first friction elements carried by the splined member, second friction elements disposed adjacent the first friction elements;
a pressure actuator means for applying a frictional engaging force to the friction elements;
a second friction disc coupling assembly having a second splined member connected to a torque transmitting element of the transmission, first friction discs carried by the second splined member, second friction discs disposed adjacent the first friction discs and a pressure actuator means for applying a frictional engaging force to the friction discs;
the notch plate having a circular planar surface adjacent the second friction disc coupling assembly; and
a coupling actuator means for applying a friction disc engaging force to said friction discs, the notch plate providing a reaction force for the frictional engaging force applied to the friction discs as the planar surface on the notch plate is engaged by an adjacent friction disc.
